(19) United States
(12) Patent Application Publication
(10) Pub. No.: US 2024/0430742 A1
(43) Pub. Date: Dec. 26, 2024

(54) ELECTRONIC APPARATUS AND CONTROL METHOD

(71) Applicant: SEIKO EPSON CORPORATION, Tokyo (JP)

(72) Inventors: Junpei KOIZUMI, MATSUMOTO-SHI (JP); Yutaka YOSHIDA, MATSUMOTO-SHI (JP)

(21) Appl. No.: 18/747,203

(22) Filed: Jun. 18, 2024

(30) Foreign Application Priority Data
Jun. 20, 2023 (JP) 2023-100594

(51) Int. Cl. H04W 28/04; H04L 1/00; H04W 52/02

(52) U.S. Cl. CPC H04W 28/04; H04L 1/0017; H04W 52/0225

(57) ABSTRACT

An electronic apparatus includes a wireless communication unit performing wireless communication and a communication controller controlling communication of the wireless communication unit. When an error occurs in the wireless communication, the communication controller executes predetermined processing for resolving the error and disables a predetermined power saving function that affects the wireless communication.

The present application is based on, and claims priority from JP Application Serial Number 2023-100594, filed Jun. 20, 2023, the disclosure of which is hereby incorporated by reference herein in its entirety.

### BACKGROUND

### 1. Technical Field

The present disclosure relates to an electronic apparatus and a control method.

### 2. Related Art

In wireless communication such as Wi-Fi (registered trademark), an error may occur in wireless communication between an electronic apparatus and another device. In relation to this, for example, JP-A-2018-15997 discloses that, in a printing apparatus configured to communicate with a terminal apparatus, when a communication error occurs, a communication control unit transmits an initialization signal to a communication unit to resolve the communication error.

JP-A-2018-15997 is an example of the related art.

When an error occurs in the wireless communication of the electronic apparatus, the electronic apparatus may resolve the error by performing predetermined processing for recovery. However, even when the error is once resolved, the error may occur again. Accordingly, the convenience for the user is reduced. Therefore, there is a demand for a technique of suppressing a decrease in user convenience due to an error in wireless communication of an electronic apparatus.

### SUMMARY

An electronic apparatus according to an aspect of the present disclosure includes a wireless communication unit performing wireless communication, and a communication control unit controlling communication of the wireless communication unit, wherein, when an error occurs in the wireless communication, the communication control unit executes predetermined processing for resolving the error and disables a predetermined power saving function that affects the wireless communication.

A control method according to an aspect of the present disclosure is a control method for an electronic apparatus that performs wireless communication using a wireless communication unit, including, when an error occurs in the wireless communication, executing predetermined processing for resolving the error, and disabling a predetermined power saving function that affects the wireless communication.

### BRIEF DESCRIPTION OF THE DRAWINGS

FIG. 1 is a schematic diagram showing an example of a configuration of a communication system according to an embodiment.

FIG. 2 is a block diagram showing an example of a configuration of an electronic apparatus according to the embodiment.

FIG. 3 shows a specific configuration example of a processing unit and a wireless communication unit in the electronic apparatus according to the embodiment.

FIG. 4 is a flowchart showing an example of an operation flow of the processing unit.

### DESCRIPTION OF EMBODIMENTS

As below, an embodiment will be described with reference to the drawings. To clarify the explanation, the following description and drawings are omitted and simplified as appropriate. In the respective drawings, the same elements have the same signs, and overlapping description thereof is omitted as necessary.

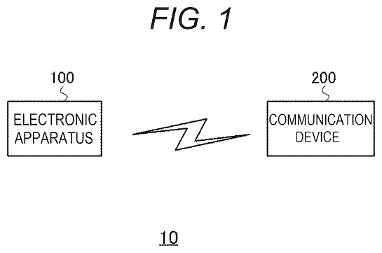

FIG. 1 is a schematic diagram showing an example of a configuration of a communication system 10 according to the embodiment. The communication system 10 includes an electronic apparatus 100 and a communication device 200 configured to perform wireless communication with the electronic apparatus 100. In the embodiment, as will be described later, the communication device 200 is used as a destination of packet transmission based on execution of a ping command for determination as to whether an error occurs in wireless communication of the electronic apparatus 100. The communication device 200 may be a device that relays wireless communication. Specifically, the communication device 200 may be, for example, a default gateway or an access point. However, the communication device 200 may not necessarily be a device that relays wireless communication. When the communication device 200 is a device that relays wireless communication, the electronic apparatus 100 may perform wireless communication with another communication device via the communication device 200. Alternatively, the electronic apparatus 100 may perform wireless communication with another communication device without using the communication device 200.

The electronic apparatus 100 may be any apparatus including a configuration that performs wireless communication. The embodiment shows a technique for suppressing a decrease in user convenience of the electronic apparatus 100 due to an error in wireless communication occurring in the electronic apparatus 100. The embodiment shows a configuration when the electronic apparatus 100 is an apparatus having a printing function, that is, a printer, however, the electronic apparatus 100 may not necessarily have a printing function. The electronic apparatus 100 may have one or more other functions instead of the printing function or in addition to the printing function. For example, the electronic apparatus 100 may have a scanner function, a facsimile function, or a copy function.

As described above, the electronic apparatus 100 performs wireless communication with another device. The wireless communication performed by the electronic apparatus 100 may be wireless communication according to a known wireless communication standard. In the embodiment, as an example, the electronic apparatus 100 performs communication using the Wi-Fi (registered trademark) system. The Wi-Fi system is, for example, a wireless communication system based on a standard of IEEE (Institute of Electrical and Electronics Engineers) 802.11 and a standard equivalent thereto.

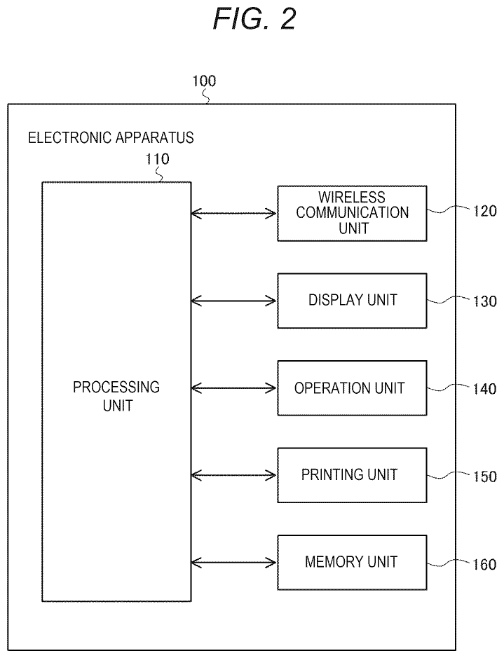

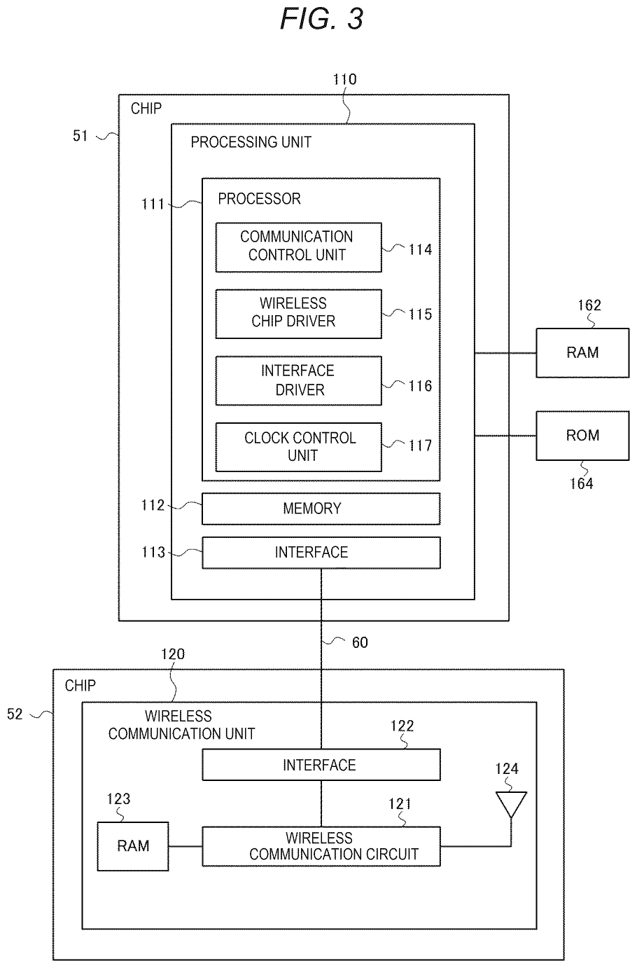

FIG. 2 is a block diagram showing an example of a configuration of the electronic apparatus 100 according to the embodiment. FIG. 3 shows a specific configuration example of a processing unit 110 and a wireless communication unit 120 in the electronic apparatus 100.

As shown in FIG. 2, the electronic apparatus 100 includes the processing unit 110, the wireless communication unit 120, a display unit 130, an operation unit 140, a printing unit 150, and a memory unit 160.

The processing unit 110 controls the respective units of the electronic apparatus 100. The respective units of the electronic apparatus 100 include, for example, the wireless communication unit 120, the display unit 130, the operation unit 140, the printing unit 150, and the memory unit 160. In the embodiment, the processing unit 110 has a function as a computer, and is configured as an SoC (System on a chip) as an example. Specifically, as shown in FIG. 3, the processing unit 110 is contained in a chip 51. The chip 51 is, for example, a semiconductor chip. As described above, in the embodiment, the processing unit 110 includes an integrated circuit. The processing unit 110 includes a processor 111, a memory 112, and an interface 113. The processor 111 is a processor that performs processing related to a wireless communication function the electronic apparatus 100. The processing unit 110 may include another processor that performs processing related to another function of the electronic apparatus 100, and the processor 111 may perform processing related to another function in addition to the processing related to the wireless communication function.

The wireless communication unit 120 performs wireless communication conforming to, for example, a predetermined wireless communication standard with a device other than the electronic apparatus 100. For example, the wireless communication unit 120 performs wireless communication conforming to a predetermined wireless LAN (Local Area Network) standard. In the embodiment, specifically, wireless communication conforming to, for example, a Wi-Fi (registered trademark) standard as one of wireless LAN standards is performed. In the embodiment, as shown in FIG. 3, the wireless communication unit 120 is contained in a chip 52. The chip 52 is, for example, a semiconductor chip. As described above, in the embodiment, the wireless communication unit 120 includes an integrated circuit. The wireless communication unit 120 may include a wireless communication circuit of a standard other than the wireless LAN standard. For example, the wireless communication unit 120 may include a wireless communication circuit of a standard of near field wireless communication such as Bluetooth (registered trademark). Specifically, the unit may include a wireless communication circuit of the BLE (Bluetooth Low Energy) standard.

The display unit 130 and the operation unit 140 are user interfaces. The display unit 130 includes a display or the like that displays various types of information to the user. The operation unit 140 includes a button or the like that receives an input operation from the user. The display unit 130 and the operation unit 140 may be integrally formed using a touch panel or the like.

The printing unit 150 has a printing function for forming an image on a printing medium such as a paper sheet. The printing unit 150 includes a printing engine. The printing engine is a mechanical configuration that prints an image on the printing medium using a color material. The printing engine may include, for example, a mechanism for printing using ink by an inkjet method. Alternatively, the printing engine may include, for example, a mechanism for printing using toner by electrophotography. The printing engine may include a transport mechanism that transports the printing medium.

The memory unit 160 stores various types of information such as data and programs. For example, the processing unit 110 and the wireless communication unit 120 may use the memory unit 160 as a work area. The memory unit 160 may be a semiconductor memory such as an SRAM (Static Random Access Memory) or a DRAM (Dynamic Random Access Memory), a register, a magnetic storage device, or an optical storage device. The memory unit 160 may store data transmitted from another device through wireless communication. The data may be data used for printing by the printing unit 150.

As below, the details of the processing unit 110 and the wireless communication unit 120 in the electronic apparatus 100 will be described with reference to FIG. 3.

The processing unit 110 includes the processor 111, the memory 112, and the interface 113. The processor 111 is, for example, a CPU (Central Processing Unit), but may be a GPU (Graphic Processing Unit), a DSP (Digital Signal Processor), or the like. The memory 112 includes a volatile memory, a nonvolatile memory, or a combination thereof. The memory 112 is used to store programs to be executed by the processor 111, data to be used for various types of processing of the processing unit 110, and the like. The processor 111 reads a program from the memory 112 and executes the program to perform processing for realizing each function of the processing unit 110 shown in FIG. 2. The processor 111 may use a program or data stored in a RAM (Random Access Memory) 162 or a ROM (Read Only Memory) 164 instead of the memory 112 or in addition to the memory 112. In the embodiment, specifically, the processor 111 performs processing of a communication control unit 114, processing of a wireless chip driver 115, processing of an interface driver 116, and processing of a clock control unit 117. The communication control unit 114, the wireless chip driver 115, the interface driver 116, and the clock control unit 117 will be described later. The processor 111 may further perform other processing.

The interface 113 is an interface for performing wired communication between internal devices of the electronic apparatus 100, for example. Specifically, the interface 113 is an interface circuit for the processing unit 110 to communicate with the wireless communication unit 120. The interface 113 is, for example, a serial interface that enables high-speed serial transfer. Specifically, the interface 113 is, for example, a USB (universal serial bus) communication standard interface, but may be an interface of another communication standard. The processing unit 110 may be connected to the RAM 162 and the ROM 164 forming the memory unit 160 in FIG. 2. The RAM 162 and the ROM 164 may be contained in the chip 51 or may be contained in the processing unit 110. The RAM 162 is, for example, an SRAM or a DRAM, and may be used as a work area of the processing unit 110. The ROM 164 is a memory configured to hold information even when power supply is interrupted. The ROM 164 may be a ROM called a nonvolatile memory such as an EEPROM (Electrically Erasable Programmable Read-Only Memory) configured to electrically erase data, or may be a mask ROM.

The wireless communication unit 120 includes a wireless communication circuit 121, an interface 122, a RAM 123, and an antenna 124. As described above, the wireless communication circuit 121 may include a plurality of wireless communication circuits of different standards such as wireless LAN and near field communication.

The wireless communication circuit 121 performs wireless communication with an external device using the antenna 124. The wireless communication circuit 121 may include, for example, a transceiver that is a circuit of a physical layer of wireless communication and a communication processing circuit that performs processing of a link layer and the like. The transceiver includes, for example, a transmitting circuit and a receiving circuit for wireless communication. The communication processing circuit may be realized by a processor such as a CPU. The interface 122 is, for example, a serial interface that enables high-speed serial transfer and has the same communication standard as the interface 113 of the processing unit 110. For example, the interface 122 is a USB communication standard interface. The interface 113 of the processing unit 110 and the interface 122 of the wireless communication unit 120 are connected via a bus 60. The RAM 123 temporarily stores various data and programs. The communication processing circuit of the wireless communication circuit 121 may operate using the RAM 123 as a work area.

Next, the wireless chip driver 115, the interface driver 116, the clock control unit 117, and the communication control unit 114, which are processed by the processing unit 110, will be described.

The wireless chip driver 115 is a device driver of the wireless communication unit 120. That is, the wireless chip driver 115 is software for operating the wireless communication unit 120. Specifically, the wireless chip driver 115 is software such as a program for controlling the operation of the wireless communication circuit 121 of the wireless communication unit 120. The wireless chip driver 115 has a function of executing wireless communication by operating the wireless communication unit 120 in a power saving mode. Specifically, in the embodiment, the wireless chip driver 115 can operate the wireless communication unit 120 in a power saving (Power Save) mode of the IEEE 802.11 standard. The wireless chip driver 115 can also execute wireless communication by operating the wireless communication unit 120 in a non-power saving mode. That is, the wireless chip driver 115 can operate the wireless communication unit 120 in a mode other than the power saving mode (that is, the non-power saving mode). In the embodiment, the wireless chip driver 115 operates the wireless communication unit 120 in a mode designated by the communication control unit 114.

The interface driver 116 is a device driver of the bus 60 for the processing unit 110 to perform communication connection with the wireless communication unit 120. That is, the interface driver 116 is software for controlling the communication connection between the processing unit 110 (chip 51) and the wireless communication unit 120 (chip 52). Specifically, in the embodiment, the interface driver 116 is a USB host driver. The interface driver 116 also controls power supply to the wireless communication unit 120 by a VBUS of USB. When the predetermined power saving function is enabled, the communication connection between the processing unit 110 and the wireless communication unit 120 may transition into the power saving mode. In the embodiment, the predetermined power saving function is specifically a USB Auto Suspend function. In a case where the USB Auto Suspend function is enabled, when the communication between the processing unit 110 and the wireless communication unit 120 is interrupted for a predetermined time or more, the interface driver 116 stops normal power supply to the wireless communication unit 120 by the VBUS to further suppress the power consumption. That is, the interface driver 116 shifts the communication connection from the non-power saving mode (active state) to the power saving mode (suspended state). That is, the power supply state for communication connection transitions from the non-power saving mode (active state) to the power saving mode (suspended state). After that, when communication is made, the interface driver 116 starts the normal power supply again. That is, the interface driver 116 shifts the communication connection from the power saving mode (suspended state) to the non-power saving mode (active state). That is, the power supply state for communication connection transitions from the power saving mode (suspended state) to the non-power saving mode (active state). In contrast, when the USB Auto Suspend function is not enabled, that is, when the function is disabled, the interface driver 116 continues normal power supply to the wireless communication unit 120 regardless of whether communication is made between the processing unit 110 and the wireless communication unit 120. That is, the interface driver 116 performs communication connection in the non-power saving mode (active state) regardless of whether communication is made. That is, the power supply state for communication connection is maintained in the non-power saving mode (active state). In the embodiment, the communication control unit 114 designates whether to enable the above described predetermined power saving function (USB Auto Suspend function) for the communication connection between the processing unit 110 and the wireless communication unit 120.

The clock control unit 117 controls the clock frequency of the processor 111 of the processing unit 110. For example, the clock control unit 117 performs control to change the clock frequency from a first frequency (maximum frequency) to a predetermined second frequency or return the clock frequency from the second frequency to the first frequency. Here, the second frequency is lower than the first frequency. When the processor 111 operates at the clock frequency of the second frequency, the processing unit 110 can operate with less power than when the processor 111 operates at the clock frequency of the first frequency. A mode in which the processor 111 operates at the clock frequency of the first frequency may be referred to as a non-power saving mode. Similarly, a mode in which the processor 111 operates at the clock frequency of the second frequency may be referred to as a power saving mode. In this manner, the clock control unit 117 controls switching between the non-power saving mode and the power saving mode. In the embodiment, the clock control unit 117 operates the processor 111 in a mode according to an instruction from the communication control unit 114. The processing unit 110 may not necessarily have a function of changing the clock frequency, in this case, the processing unit 110 may not include the clock control unit 117.

The communication control unit 114 controls wireless communication of the electronic apparatus 100. That is, the communication control unit 114 controls communication of the wireless communication unit 120. In the embodiment, the communication control unit 114 executes not only transmission control processing of controlling transmission and reception of data by wireless communication, but also, particularly, processing related to a wireless communication error. As below, the processing related to a wireless communication error performed by the communication control unit 114 will be described. The wireless communication error refers to a state in which wireless communication is not normally performed, and may also be referred to as a wireless connection error.

The communication control unit 114 performs processing of detecting of occurrence a wireless communication error (hereinafter also referred to as error detection processing). Specifically, the communication control unit 114 determines whether an error occurs in wireless communication by periodically transmitting a packet to the communication device 200 as an example of a predetermined device. The communication control unit 114 transmits packets, for example, at intervals of 10 minutes. More specifically, the communication control unit 114 determines a state of wireless communication connection of the wireless communication unit 120 by executing the ping command and transmitting a packet to the communication device 200. That is, the communication control unit 114 determines whether an error occurs in wireless communication by confirming a response to the packet transmitted by the execution of the ping command. When a response is obtained from the communication device 200, the communication control unit 114 determines that no error occurs in the wireless communication by the wireless communication unit 120. In contrast, when no response is obtained from the communication device 200, the communication control unit 114 determines that an error occurs in the wireless communication by the wireless communication unit 120. A wireless communication error is detected by the periodic packet transmission, and thereby, the wireless communication error can be detected earlier. Therefore, wireless communication error can be resolved earlier. Accordingly, it can be expected that the error is resolved before the user notices the wireless communication error.

Note that the communication control unit 114 may perform the error detection processing only in the following case. The communication control unit 114 may perform the above described error detection processing only when a response to the transmission of a packet from the electronic apparatus 100 (the wireless communication unit 120) is normally received from the communication device 200. For example, when an IP (Internet protocol) address of the communication device 200 is not set in advance for the electronic apparatus 100 or when there is an error in the set IP address of the communication device 200, the communication control unit 114 may omit the error detection processing.

When determining that an error occurs in the wireless communication, the communication control unit 114 executes predetermined processing (hereinafter, also referred to as error resolution processing) for resolving the occurred error and control (hereinafter, also referred to as a power-save disabling control) of disabling a the predetermined power saving function that affects wireless communication.

First, the error resolution processing will be described. In the embodiment, when determining that an error occurs in the wireless communication, the communication control unit 114 performs at least one of the following three pieces of error resolution processing as the error resolution processing. However, these are merely specific examples of the error resolution processing, and the communication control unit 114 may execute predetermined error resolution processing different from the following three pieces of error resolution processing.

The communication control unit 114 reinstalls the wireless chip driver 115 as first error resolution processing. That is, the communication control unit 114 uninstalls the wireless chip driver 115 and installs the wireless chip driver 115 after the uninstallation.

The wireless chip driver 115 is stored in, for example, the ROM 164, and a driver is installed by reading of the wireless chip driver 115 from the ROM 164. That is, installation to incorporate the wireless chip driver 115 in an execution program of the processor 111 to be executable is performed. In the first error resolution processing, first, the communication control unit 114 uninstalls the installed wireless chip driver 115. That is, uninstallation to delete the wireless chip driver 115 from the execution program of the processor 111 is performed. In this regard, the communication control unit 114 may perform negotiation processing or the like with the wireless communication unit 120 to initialize various settings set in a register or the like of the wireless communication circuit 121. In the first error resolution processing, the communication control unit 114 reinstalls the wireless chip driver 115 from the ROM 164 after the uninstallation. Thereby, when there is a defect in register setting or the like of the wireless communication circuit 121 controlled by the wireless chip driver 115 and when there is a defect in the wireless chip driver 115, these defects can be eliminated. For example, even when the register setting of the wireless communication circuit 121 is lost or changed to a wrong setting, the register setting or the like of the wireless communication circuit 121 can be restored to a correct setting by the wireless chip driver 115 newly installed after uninstallation. The state of the memory used in the wireless chip driver 115 can also be reset by uninstallation of the wireless chip driver 115. Accordingly, the first error resolution processing is executed, and thereby, a wireless communication error caused by a problem occurring in the operation of the wireless chip driver 115 or the operation of the wireless communication unit 120 can be resolved.

Further, the communication control unit 114 performs interrupts the power supply to the wireless communication unit 120 and resumes the power supply after the interruption of the power supply as second error resolution processing. That is, the communication control unit 114 performs hardware reset of the wireless communication unit 120 as the second error resolution processing. For example, when power is supplied to the wireless communication unit 120 by the VBUS of USB, first, the communication control unit 114 does not supply power by the VBUS. After the power supply is interrupted, the communication control unit 114 resumes the power supply by the VBUS. In the embodiment, specifically, the communication control unit 114 instructs the interface driver 116 to interrupt the power supply to wireless communication unit 120. Further the communication control unit 114 instructs the interface driver 116 to resume the power supply to the wireless communication unit 120. Thereby, the interruption and the resumption of the power supply to the wireless communication unit 120 are realized. When the power supply is interrupted and resumed in this manner, the register setting or the like of the wireless communication circuit 121 is initialized, and thus a wireless communication error can be resolved.

Furthermore, the communication control unit 114 reboots the communication control unit 114 itself as third error resolution processing. That is, the communication control unit 114 reboots software operating as the communication control unit 114. An error may occur in wireless communication due to an abnormality in transmission control processing executed by the communication control unit 114. In such a case, the communication control unit 114 is rebooted, and thereby, the operating condition of the software functioning as the communication control unit 114 and the condition of the memory used for the operation of the software can be returned to the conditions at the time of the software start-up. Accordingly, the operation of the software can be stabilized, and the error of the wireless communication can be resolved.

When determining that an error occurs in the wireless communication, the communication control unit 114 may execute any one of the plurality of pieces of predetermined error resolution processing or may sequentially execute two or more pieces of processing. When sequentially executing the two or more pieces of error resolution processing, the communication control unit 114 may sequentially execute the pieces of error resolution processing in a predetermined order until the error is resolved. That is, when the error is not resolved by k-th (k is an integer of 1 or more) error resolution processing, the communication control unit 114 may execute (k+1)-th error resolution processing. The (k+1)-th error resolution processing is different from the k-th error resolution processing. The communication control unit 114 may execute a plurality of pieces of error resolution processing in an ascending order of processing time until the error is resolved. That is, the above described predetermined order may be an ascending order of the processing time. Thereby, the time required to resolve the error can be suppressed to the minimum time, and the convenience for the user can be improved. In the embodiment, among the first to third error resolution processing, the first error resolution processing can be executed in the shortest time. Among the first to third error resolution processing, processing with a longer processing time next to the first error resolution processing is the second error resolution processing. This is because it takes time to stabilize the power supply voltage. In the embodiment, among the first to third error resolution processing, the third error resolution process requiring a long time for reboot has the longest processing time. Therefore, for example, when determining that an error occurs in the wireless communication, the communication control unit 114 may execute the error resolution processing in the following manner. First, the communication control unit 114 executes the first error resolution processing. When the error is not resolved thereby, the unit executes the second error resolution processing. When the error remains unresolved, the unit finally executes the third error resolution processing. The communication control unit 114 may execute a plurality of pieces of error resolution processing regardless of whether the error is resolved by the execution of one piece of error resolution processing.

When the second error resolution processing as the error resolution processing with temporary interruption of power supply to the wireless communication unit 120 is performed, the second error resolution processing and the first error resolution processing with the reinstallation of the wireless chip driver 115 may be performed in the following order. First, the communication control unit 114 uninstalls the installed wireless chip driver 115. Then, the communication control unit 114 sequentially interrupts the power supply to the wireless communication unit 120 and resumes the power supply after the interruption of power supply. Then, the communication control unit 114 reinstalls the wireless chip driver 115. According to the above described procedure, when the power supply is interrupted, the wireless chip driver 115 can be prevented from failing to recognize the wireless communication unit 120, and the chance of occurrence of a defect due to the failure can be suppressed.

Next, the power-save disabling control will be described. In the embodiment, when determining that an error occurs in wireless communication, the communication control unit 114 executes at least one of the following three power-save disabling controls as a power-save disabling control. However, these are merely specific example of the power-save disabling control, and the communication control unit 114 may execute a predetermined power-save disabling control different from the following three power-save disabling controls.

The communication control unit 114 performs a control to prevent the communication connection between the processing unit 110 and the wireless communication unit 120 from transitioning to the power saving mode as first power-save disabling control. In the embodiment, specifically, the communication control unit 114 performs a control to disable the USB Auto Suspend function. Accordingly, the condition of power supply to the wireless communication unit 120 may be unvaried. The inventors have found that a wireless communication error is likely to occur, for example, when wireless communication occurs at a time in the middle of transition of the communication connection mode from the non-power saving mode (active state) to the power saving mode (suspended state) or at a time in the middle of return from the power saving mode to the non-power saving mode. The communication connection between the processing unit 110 and the wireless communication unit 120 is prevented from transitioning to the power saving mode (suspended state), and thereby, the chance that, after the wireless communication error is resolved, a wireless communication error occurs again can be suppressed.

Further, the communication control unit 114 performs a control to prohibit the clock frequency of the processor 111 as the processor that performs processing related to wireless communication from decreasing from the first frequency to the second frequency as second power-save disabling control. The clock frequency of the processor 111 may be regarded as the clock frequency of the processor that performs the processing of the communication control unit 114, and may be regarded as the clock frequency of the processor that performs the processing of the wireless chip driver 115 or the interface driver 116. Here, the first frequency is, for example, the maximum clock frequency, and the second frequency is, for example, a predetermined frequency lower than the maximum clock frequency. The clock frequency is prevented from being changed, and thereby, the occurrence of a wireless communication error caused by wireless communication at the time when the clock frequency varies can be suppressed. In addition, the occurrence of a wireless communication error caused by a decrease in processing capacity of the processor 111 due to a decrease in clock frequency can be suppressed. Therefore, after the wireless communication error is resolved, the chance that a wireless communication error occurs again can be suppressed.

Furthermore, the communication control unit 114 performs a control to operate the wireless communication unit 120 in the non-power saving mode as third power-save disabling control. That is, the communication control unit 114 performs a control to operate wireless communication by the wireless communication unit 120 in the non-power saving mode. In other words, the communication control unit 114 controls the wireless communication unit 120 not to operate in the power saving mode. In the embodiment, specifically, the communication control unit 114 controls not to operate the wireless communication unit 120 in the power-save mode of the IEEE 802.11 standard, but to operate the wireless communication unit 120 in the non-power saving mode in which the power-save mode is not activated. Accordingly, wireless communication can be realized more stably and reliably as compared with the case of operation in the power saving mode. Further, when there is a wireless communication error caused by the operation in the power saving mode such as the power-save mode, the third power-save disabling control can also contribute to suppression of the chance of the occurrence of the wireless communication error.

When determining that an error occurs in the wireless communication, the communication control unit 114 may execute any one of the plurality of predetermined power-save disabling controls or may execute two or more controls. In addition, the communication control unit 114 may determine which power-save disabling control to perform in the following manner.

The communication control unit 114 may perform the first power-save disabling control when the frequency of the transition between the non-power saving mode and the power saving mode in the communication connection is equal to or higher than a predetermined threshold in a predetermined period until the time when a wireless communication error occurs. Here, the time when a wireless communication error occurs refers to a time when a determination that an error occurs in the wireless communication is made by the error detection processing of the communication control unit 114. As described above, when wireless communication occurs at a time during the mode change, a wireless communication error is likely to occur. Accordingly, when the mode transition frequency in the predetermined period until the time when a wireless communication error occurs is equal to or higher than the predetermined threshold, the chance that an error due to the mode change occurs is higher. Therefore, in such a case, the first power-save disabling control is performed, and thereby, the chance that the same error reoccurs can be suppressed.

When a load rate (for example, CPU usage rate) of the processor 111 at the time when a wireless communication error occurs is equal to or higher than a predetermined threshold, the communication control unit 114 may perform the second power-save disabling control. When the load rate of the processor 111 at the time of the error is higher, an error due to the lower processing capacity of the processor 111 may occur. Therefore, when the load rate of the processor 111 at the time when a wireless communication error occurs is equal to or higher than the predetermined threshold, the second power-save disabling control is performed, and thereby, the chance that the same error reoccurs can be suppressed.

The executed power-save disabling control is continued until the active state of the electronic apparatus 100 is ended. In other words, the power-save disabling control is continued until the electronic apparatus 100 is powered off. When the electronic apparatus 100 is restarted, the communication control unit 114 enables a predetermined power saving function. For example, the communication control unit 114 performs a control to enable all the power saving functions. Note that the communication control unit 114 may perform a control to enable only part of the power saving functions when the electronic apparatus 100 is activated. Under the control, the operation of the electronic apparatus 100 in power saving can be restarted.

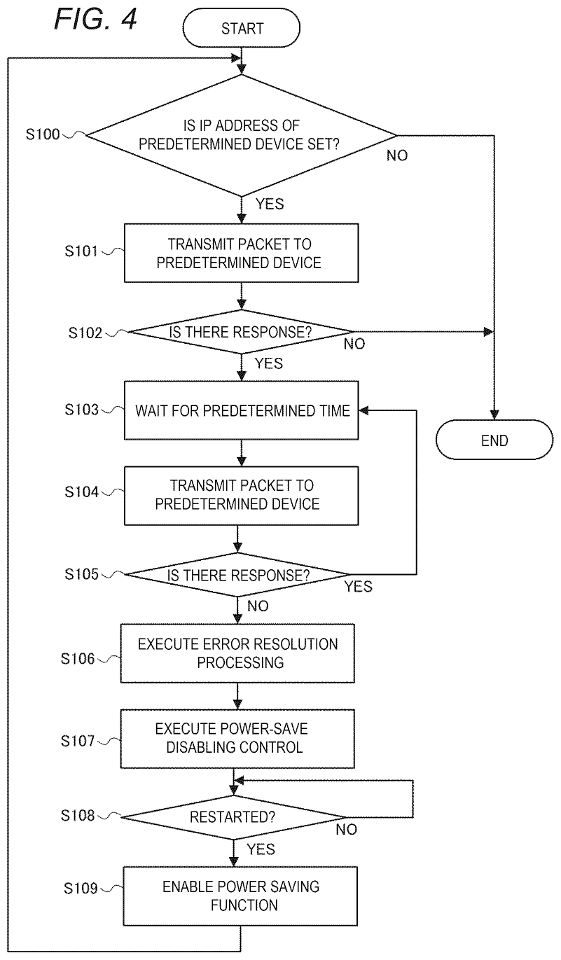

Next, an operation flow of the processing unit 110 related to a wireless communication error will be described. FIG. 4 is a flowchart showing an example of the operation flow of the processing unit 110. As below, the operation flow will be described with reference to FIG. 4. For example, this flow is started when the electronic apparatus 100 succeeds in wireless connection with any other device, but this flow may be started at any time.

First, in preparation for the error detection processing, the processing from step S100 to step S102 is performed.

At step S100, the communication control unit 114 determines whether the IP address of the communication device 200 as an example of a predetermined apparatus is set in advance for the electronic apparatus 100. When the communication device 200 is, for example, a default gateway, at step S100, the communication control unit 114 determines whether the IP address of the default gateway is set in the electronic apparatus 100. When the IP address is not set (NO at step S100), the error detection processing is appropriately performed, and thus the flow related to a wireless communication error ends. When the IP address is set (YES at step S100), the processing goes to step S101.

At step S101, the communication control unit 114 executes the ping command and transmits a packet to the communication device 200. That is, the communication control unit 114 transmits a packet addressed to the IP address of the communication device 200 using the wireless communication unit 120. After step S101, the processing goes to step S102.

At step S102, the communication control unit 114 determines whether a response to the packet transmitted at step S101 is obtained. When there is no response from the communication device 200 (NO at step S102), the error detection processing is not appropriately performed, and thus the flow related to a wireless communication error ends. For example, when there is an error in the IP address of the communication device 200 set by the user, NO is determined at step S102. When the response is obtained (YES at step S102), the error detection processing is appropriately performed, and thus the processing goes to step S103 and the subsequent steps. As described above, whether execution of the processing at step S103 and the subsequent steps is appropriate is determined from step S100 to step S102, and thereby, a false determination that an error occurs by the error detection processing can be prevented. Therefore, the error resolution processing and the power-save disabling control despite the absence of an error can be avoided.

At steps S103 to S105, the error detection processing is performed. At step S103, the communication control unit 114 waits for a certain period of time. Then, at step S104, the communication control unit 114 executes the ping command to transmit a packet to the communication device 200. That is, the communication control unit 114 transmits a packet addressed to the IP address of the communication device 200 using the wireless communication unit 120. After step S104, the processing goes to step S105. At step S105, the communication control unit 114 determines whether a response to the packet transmitted at step S104 is obtained. When a response from the communication device 200 is obtained (YES at step S105), the communication control unit 114 determines that no error occurs in the wireless communication. In this case, the processing returns to step S103. When no response from the communication device 200 is obtained (NO in step S105), the communication control unit 114 determines that an error occurs in the wireless communication. In this case, the processing goes to step S106.

At step S106, the communication control unit 114 executes the error resolution processing. In the embodiment, the communication control unit 114 executes at least one piece of the above described first to third error resolution processing. After step S106, the processing goes to step S107. At step S107, the communication control unit 114 executes the power-save disabling control. In the embodiment, at least one of the above described first to third power-save disabling controls is executed. The power-saving disabling control continues until the electronic apparatus is restarted. Therefore, after step S107, at step S108, the communication control unit 114 determines whether the electronic apparatus 100 is restarted. When the electronic apparatus 100 is restarted, the processing goes to step S109. At step S109, the communication control unit 114 enables the power saving function. Then, the processing returns to step S100.

As above, the embodiment is described. In the embodiment, when an error occurs in the wireless communication, the communication control unit 114 executes the error resolution processing and executes the power-save disabling control. Therefore, reoccurrence of a wireless communication error can be suppressed and the convenience for the user can be increased. In the flowchart shown in FIG. 4, the power-save disabling control is performed after the error resolution processing, however, these may be performed in the reverse order or in parallel.

Although the embodiment is described above, the present disclosure is not limited to the above described embodiment, and can be appropriately changed without departing from the gist of the present disclosure.

In the above described example, the program includes a command group (or software codes) for causing a computer to perform one or more functions described in the embodiment when the program is read by the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD) or other memory technologies, a CD-ROM, a digital versatile disk (DVD), a Blu-ray (registered trademark) disk or other optical disk storages, a magnetic cassette, a magnetic tape, and a magnetic disk storage or other magnetic storage devices. The program may be transmitted on a transitory computer-readable medium or a communication medium. Examples of the transitory computer-readable medium or the communication medium include, but are not limited to, electrical, optical, acoustic, or other forms of propagating signals.

A part or all of the above described embodiment may be described as in the following appendixes, but are not limited thereto.

### APPENDIX 1

An electronic apparatus includes a wireless communication unit performing wireless communication, and a communication control unit controlling communication of the wireless communication unit, wherein, when an error occurs in the wireless communication, the communication control unit executes predetermined processing for resolving the error and disables a predetermined power saving function that affects the wireless communication.

### APPENDIX 2

In the electronic apparatus according to Appendix 1, the communication control unit enables the predetermined power saving function when the electronic apparatus is restarted.

### APPENDIX 3

In the electronic apparatus according to Appendix 1 or 2, the communication control unit determines whether the error occurs by periodically transmitting a packet to a predetermined device.

### APPENDIX 4

In the electronic apparatus according to any one of Appendices 1 to 3, the communication control unit executes a plurality of pieces of predetermined processing for resolving the error in ascending order of processing time until the error is resolved.

### APPENDIX 5

In the electronic apparatus according to any one of Appendices 1 to 4, the communication control unit performs control to prevent communication connection between a processing unit including the communication control unit and the wireless communication unit from transitioning to a power saving mode as control to disable the predetermined power saving function.

### APPENDIX 6

In the electronic apparatus according to Appendix 5, the communication control unit performs control to prevent the communication connection from transitioning to the power saving mode when a transition frequency between a non-power saving mode and the power saving mode in the communication connection is equal to or higher than a predetermined threshold in a predetermined period until a time when the error occurs.

### APPENDIX 7

In the electronic apparatus according to any one of Appendices 1 to 6, the communication control unit performs control to prohibit a clock frequency of a processor that performs processing related to the wireless communication from decreasing from a first frequency to a second frequency as control to disable the predetermined power saving function.

### APPENDIX 8

In the electronic apparatus according to Appendix 7, the communication control unit performs control to prohibit the clock frequency from decreasing from the first frequency to the second frequency when a load rate of the processor at the time when the error occurs is equal to or higher than a predetermined threshold.

### APPENDIX 9

In the electronic apparatus according to any one of Appendices 1 to 8, the communication control unit performs control to operate the wireless communication unit in the non-power saving mode as control to disable the predetermined power saving function.

### APPENDIX 10

A control method for an electronic apparatus that performs wireless communication by a wireless communication unit, includes, when an error occurs in the wireless communication, executing predetermined processing for resolving the error, and disabling a predetermined power saving function that affects the wireless communication.

What is claimed is:

1. An electronic apparatus comprising: a wireless communication unit performing wireless communication; and a communication controller controlling communication of the wireless communication unit, wherein, when an error occurs in the wireless communication, the communication controller executes predetermined processing for resolving the error and disables a predetermined power saving function that affects the wireless communication.

2. The electronic apparatus according to claim 1, wherein, when the electronic apparatus is restarted, the communication controller enables the predetermined power saving function.

3. The electronic apparatus according to claim 1, wherein the communication controller determines whether the error occurs by periodically transmitting a packet to a predetermined device.

4. The electronic apparatus according to claim 1, wherein the communication controller executes a plurality of pieces of predetermined processing for resolving the error in ascending order of processing time until the error is resolved.

5. The electronic apparatus according to claim 1, wherein the communication controller performs control to prevent communication connection between a processor including the communication controller and the wireless communication unit from transitioning to a power saving mode as control to disable the predetermined power saving function.

6. The electronic apparatus according to claim 5, wherein the communication controller performs control to prevent the communication connection from transitioning to the power saving mode when a transition frequency between a non-power saving mode and the power saving mode in the communication connection is equal to or higher than a predetermined threshold in a predetermined period until a time when the error occurs.

7. The electronic apparatus according to claim 1, wherein the communication controller performs control to prohibit a clock frequency of a processor that performs processing related to the wireless communication from decreasing from a first frequency to a second frequency as control to disable the predetermined power saving function.

8. The electronic apparatus according to claim 7, wherein the communication controller performs control to prohibit the clock frequency from decreasing from the first frequency to the second frequency when a load rate of the processor at the time when the error occurs is equal to or higher than a predetermined threshold.

9. The electronic apparatus according to claim 1, wherein the communication controller performs control to operate the wireless communication unit in a non-power saving mode as control to disable the predetermined power saving function.

10. A control method for an electronic apparatus that performs wireless communication by a wireless communication unit, comprising: when an error occurs in the wireless communication, executing predetermined processing for resolving the error; and disabling a predetermined power saving function that affects the wireless communication.
